(19) United States
(12) Patent Application Publication
(10) Pub. No.: US 2026/0316082 A1
(43) Pub. Date: Oct. 15, 2026

(54) APPARATUS, SLEEVE AND METHOD FOR HOLDING VIALS COMPRISING LABEL RETAINER

(71) Applicant: MESOBLAST INTERNATIONAL SÀRL, Meyrin (CH)

(72) Inventor: Normand DAVIDZON, Melbourne (AU)

(21) Appl. No.: 19/482,552

(22) PCT Filed: May 8, 2024
(86) PCT No.: PCT/IB2024/054470

§ 371 Date: Nov. 7, 2025

(30) Foreign Application Priority Data
May 8, 2023 (AU) 2023901384

(51) Int. Cl. B01L 3/00; B65D 25/20; G09F 3/08

(52) U.S. Cl. CPC B01L 3/545; B65D 25/205; G09F 3/08

(57) ABSTRACT

An apparatus for labelling vials is described, the apparatus comprising: a body defining a lumen for receiving a container, wherein the apparatus comprises a connecting portion configured to engage with the container and secure the apparatus to the container, and an outer surface of the apparatus is configured to receive a label; wherein at least part of the connecting portion extends towards the lumen; and wherein the apparatus has an operating range less than approximately minus 80 degrees Celsius, at which: (i) the apparatus is configured to be mechanically and structurally stable; and (ii) the label is configured to be retained on the outer surface.

### CROSS-REFERENCE TO RELATED APPLICATIONS

This application claims priority International Patent Application No. PCT/IB2024/054470, filed May 8, 2024, which claims priority to Australian Patent Application No. 2023901384, filed May 8, 2023, each of which is incorporated by reference herein in its entirety.

### TECHNICAL FIELD

The present disclosure relates to apparatuses and methods for labelling containers such as vials and syringes. Some embodiments relate, in particular, to apparatuses and methods for labelling chilled or frozen containers, or containers that have been stored at extremely cold temperatures for medical applications.

### BACKGROUND

Some medicines and their ingredients require storage at subzero temperatures. For example, some cell compositions and vaccines may be stored at temperatures below minus 80 degrees Celsius. These products are usually stored in containers such as vials for easy storage and transportation. Some products may be stored in syringes for quick administration.

The containers are labelled with information such as the name, manufacturing date, expiry date, and batch number of the products contained within the containers. One way of labelling the container is to apply an adhesive label, either before or after the container is frozen. However, the label sometimes may not stick to the container and may eventually fall off.

It is desired to reduce or ameliorate one or more shortcomings of present apparatuses and methods for labelling containers, and particularly containers stored at subzero temperatures, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to an apparatus comprising:
a body defining a lumen for receiving a container, wherein the apparatus comprises a connecting portion configured to engage with the container and secure the apparatus to the container, and an outer surface of the apparatus is configured to receive a label;
wherein at least part of the connecting portion extends towards the lumen; and
wherein the apparatus has an operating range less than approximately minus 80 degrees Celsius, at which: (i) the apparatus is configured to be mechanically and structurally stable; and (ii) the label is configured to be retained on the outer surface.

The connecting portion may comprise a first lip defining a first aperture to the lumen, the first lip having a first elastic portion. The first lip may comprise a tapered portion that extends towards the lumen.

The apparatus may further comprise a groove defined in an inner surface of the body, wherein the first lip and the groove are configured to secure the apparatus to the container.

The apparatus may further comprise a ridge defined on an inner surface of the body, wherein the first lip and the ridge are configured to secure the apparatus to the container.

The connecting portion may further comprise a collar.

The body may be configured to be stretched over the container to clamp on to the container when the container is received in the lumen.

The operating range may comprise temperatures between minus 80 degrees Celsius to minus 200 degrees Celsius. The operating range may comprise temperatures between minus 135 degrees Celsius to minus 196 degrees Celsius.

The apparatus may comprise Ultra High Molecular Weight Polyethylene (UHMWPE) material. The apparatus may comprise stainless steel.

The apparatus may further comprise a base, wherein the base comprises a second lip, wherein the second lip defines a second aperture to the lumen and the second lip comprises a second elastic portion.

The body may comprise a transparent portion to allow visibility of the container received in the lumen of the body.

The apparatus may further comprise a label retainer configured to retain the label when the label is received by the outer surface of the body.

The label may be connected to the label retainer.

Some embodiments relate to a container arrangement comprising:
the apparatus as described herein; and
a container comprising a shoulder, the apparatus configured to engage with the shoulder of the container.

The container arrangement may further comprise a label applied to the apparatus.

Some embodiments relate to a container arrangement comprising a container received in a sleeve, wherein the sleeve comprises a connector configured to secure the sleeve to the container.

The shoulder of the container may comprise a ridge. The connector may further comprise a groove. The ridge may be configured to be received in the groove to clamp the sleeve on to the container.

The shoulder of the container may comprises a groove. The connector may further comprises a ridge. The ridge may be configured to be received in the groove to clamp the sleeve on to the container.

The connector may be configured to secure the sleeve to the container at a cryopreservation temperature. The cryopreservation temperature may be at or below minus 80 degrees Celsius. The container arrangement may further comprise a label applied to the sleeve.

Some embodiments relate to a sleeve comprising:
a body defining a lumen for receiving a container, and an outer surface of the body configured to receive a label; and
a first lip defining a first aperture to the lumen, the first lip having a first elastic portion configured to engage with the container;
wherein the body comprises a female connector configured to engage with a male connector on the container to secure the body to the container received in the lumen; and
wherein the first lip comprises a tapered portion that extends towards the lumen.

Some embodiments relate to a sleeve comprising:
a body defining a lumen for receiving a container, and an outer surface of the body configured to receive a label; and
a first lip defining a first aperture to the lumen, the first lip having a first elastic portion configured to engage with the container;
wherein the body comprises a male connector configured to engage with a female connector on the container to clamp the body to the container received in the lumen; and
wherein the first lip comprises a tapered portion that extends towards the lumen.

The female connector may comprise a groove, and the male connector may comprise a ridge. The female connector may comprise a hole, and the male connector may comprise a pin. The female connector may comprise a slot, and the male connector may comprise a tab.

Some embodiments relate to an applicator for the apparatus as described herein, for the container arrangement as described herein, or for the sleeve as described herein, the applicator comprising:
a container receiver configured to receive the container; and
a holder configured to hold the apparatus or sleeve in an open configuration;
wherein at least one of the container receiver and the holder are configured to move towards each other to place the apparatus or sleeve over the container.

Some embodiments relate to a method for labelling a cryofrozen container containing a cell composition, wherein the method comprises:
printing a label onto a sleeve or an apparatus at room temperature;
applying the sleeve to the cryofrozen container.

The sleeve may be the sleeve as described herein. The apparatus may be the apparatus as described herein.

### BRIEF DESCRIPTION OF DRAWINGS

FIG. 1A is a perspective view of a sleeve for a container, according to some embodiments;

FIG. 1B is a section view of the sleeve of FIG. 1A, taken along the line marked 1B-1B;

FIG. 1C is a close-up view of the sleeve, as indicated on FIG. 1B;

FIG. 1D is the section view of the sleeve of FIG. 1B, with example dimensions;

FIG. 2A is a perspective view of a container, such as a vial according to some embodiments;

FIG. 2B is a side view of the vial of FIG. 2A;

FIG. 2C is an exploded side view of the vial of FIG. 2A, with example dimensions;

FIG. 2D is an assembled side view of the vial of FIG. 2A, with example dimensions;

FIG. 3A is a perspective view of a vial arrangement comprising the sleeve of FIGS. 1A-1C applied to the vial of FIGS. 2A-2B, according to some embodiments;

FIG. 3B is a section view of the vial arrangement of FIG. 3A, taken along the line marked 3B-3B;

FIG. 3C is a close-up view of the vial arrangement, as indicated on FIG. 3B;

FIG. 4 is a section view of a sleeve for a vial, according to some embodiments;

FIG. 5 is a section view of the sleeve of FIG. 4 as applied to a vial, according to some embodiments; and

FIG. 6 is a perspective view of an applicator for applying the sleeve of FIG. 1A-1C or the sleeve of FIG. 4 to a vial, according to some embodiments.

### DETAILED DESCRIPTION

The present disclosure relates to apparatuses and methods for labelling containers (such as vials or syringes, for example). Some embodiments relate, in particular, to apparatuses and methods for labelling chilled, frozen, or cryofrozen containers, or containers that have been stored at extremely cold temperatures for medical applications.

In some circumstances, the contents of the container are stored at extremely cold temperatures and cannot be exposed to temperatures significantly above the storage temperature. For example, some products are stored at temperatures lower than approximately minus 80 degrees Celsius. Some products are stored at temperatures around minus 145 degrees Celsius. Exposing the container to temperatures above this storage temperature may cause the product contained in the container to degrade.

While the container can be labelled before freezing, there may be a need to relabel the frozen container. For example, the original label may be damaged or contain out of date information.

The inventors have identified that applying a label to a frozen container may be complicated due to frost/condensation on the outside of the container. Furthermore, the inventors have identified that hand-applying a label to a frozen container presents difficulties relating to worker safety, efficiency, and/or product degradation. These difficulties are discussed in more detail herein.

The inventors have developed an apparatus and method for labelling a frozen container without requiring the frozen container to be brought to a warmer temperature (potentially degrading the product stored therein) in order for the adhesive to work properly. The inventors' apparatus and method provides an alternative to hand-labelling the frozen containers. The inventors' apparatus and method may also be used to label containers that have not been frozen.

### GENERAL DISCLOSURE OF THE EMBODIMENTS

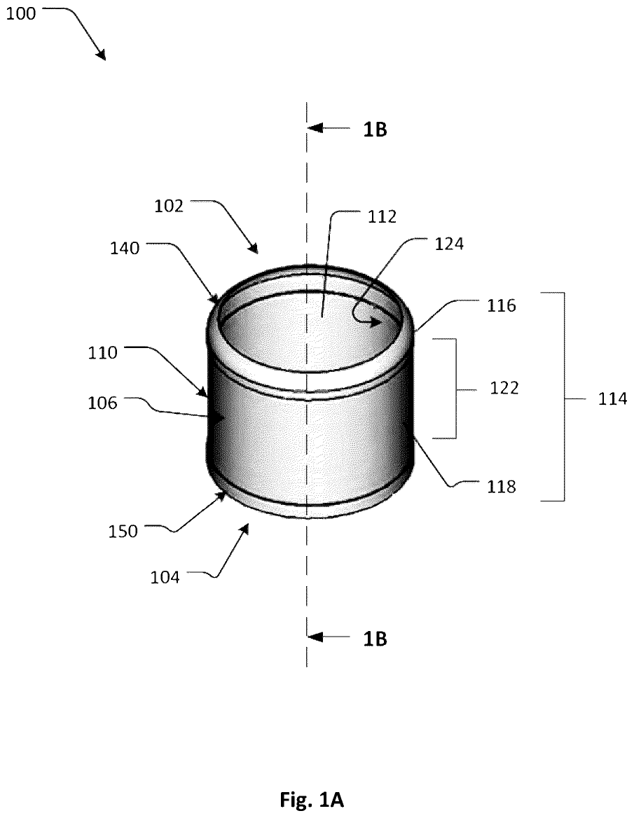

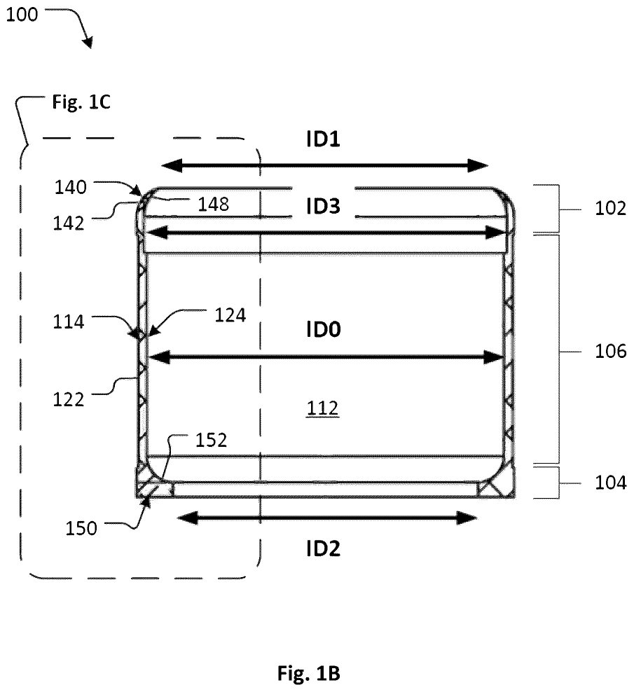

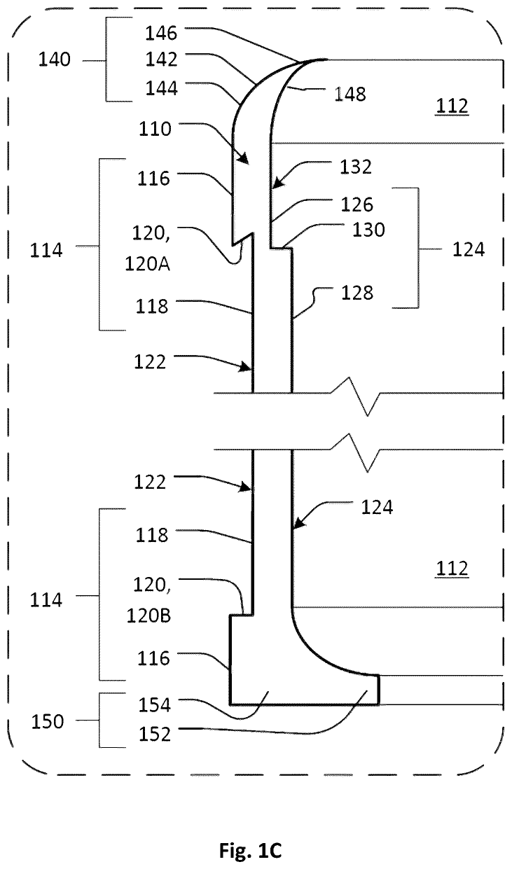

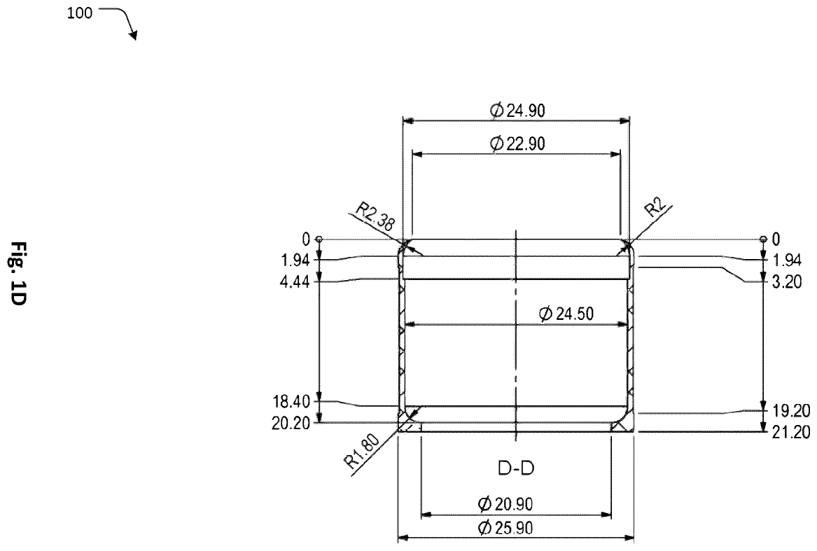

FIGS. 1A-1C show an apparatus 100 for labelling a container, according to some embodiments. The apparatus 100 may be configured to label a cylindrical container, such as a vial or syringe. An outer surface of the apparatus 100 is configured to receive a label. The outer surface of the apparatus 100 may comprise a groove or recess to receive the label. The label may contain information relating to the contents of the container. Hereon, a vial will be used as an example of a cylindrical container, although it is understood that other containers may be included, such as a syringe.

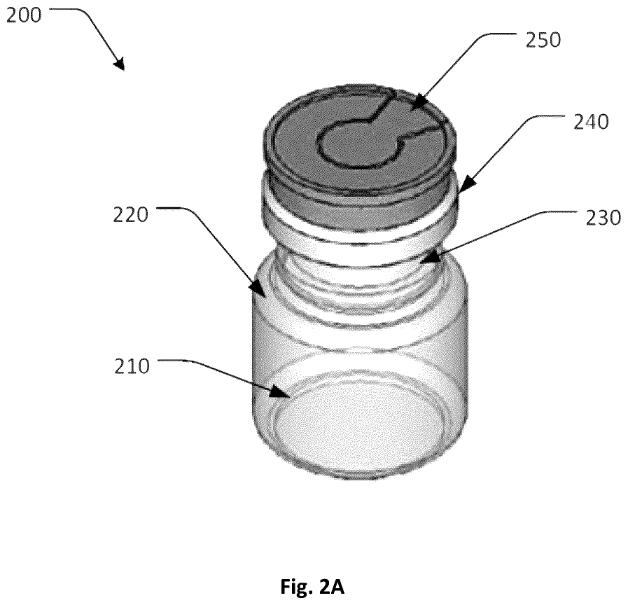

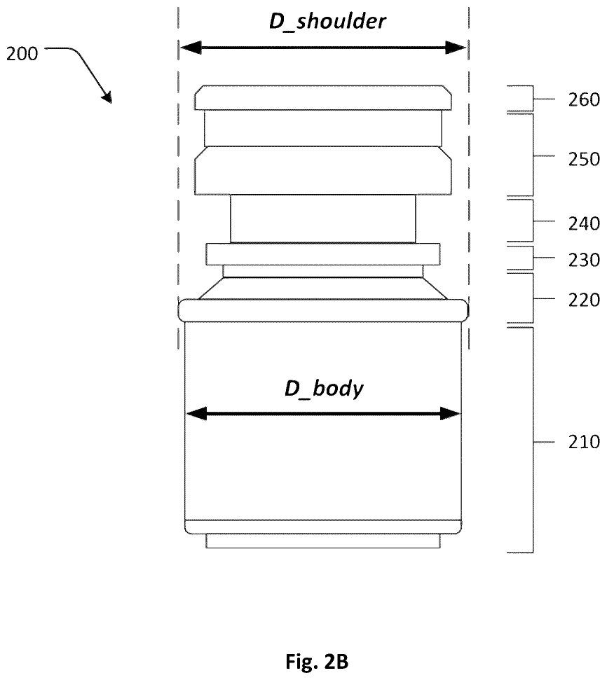

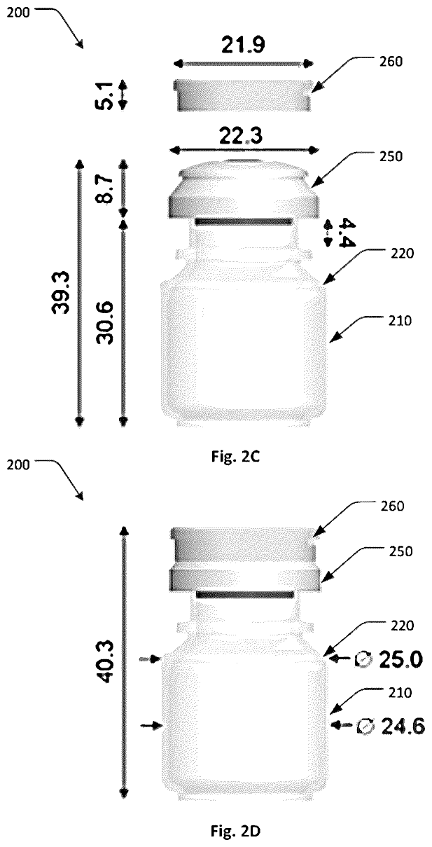

The apparatus 100 may generally resemble a tube or sleeve that is configured to fit around, or receive, a container 200 (such as the vial 200 shown in FIGS. 2A and 2B). The apparatus 100 may comprise an elastic portion that is configured to stretch around the vial 200 and to couple or secure the apparatus 100 to the vial 200. For example, the apparatus 100 comprises a body that may be configured to be stretched over the vial 200 to clamp on (or be otherwise secured) to the vial 200 when the vial 200 is received in the lumen 112.

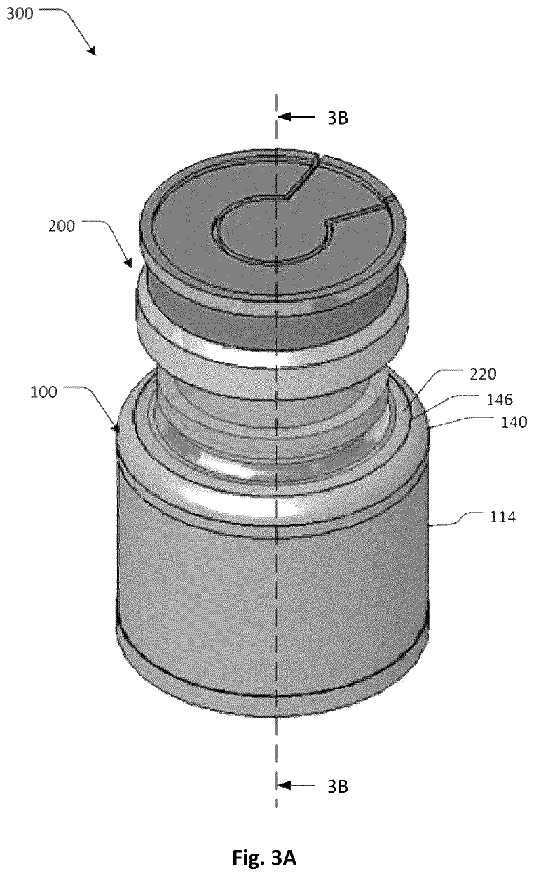

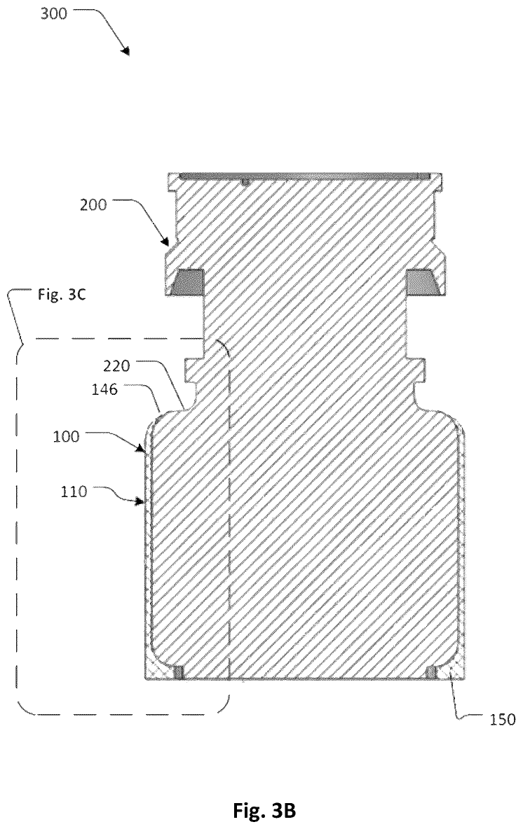

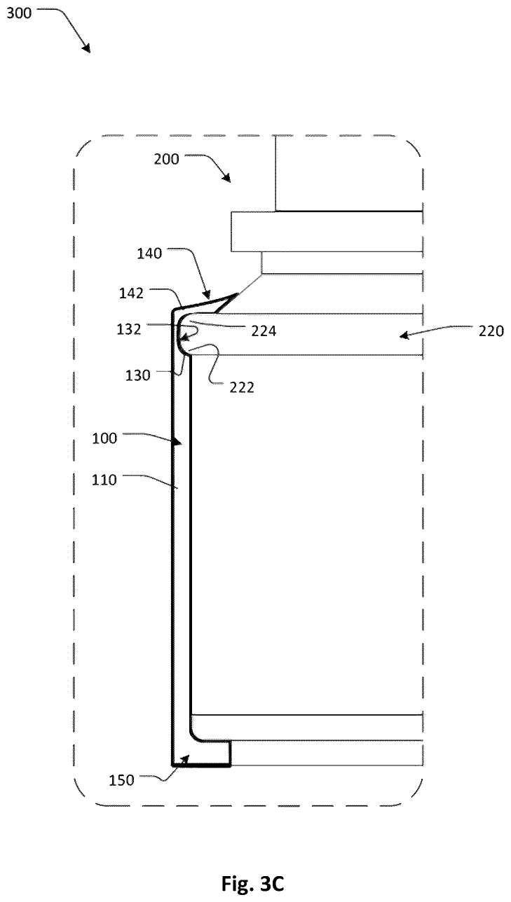

The vial 200 may have a body 210 and a shoulder 220. In embodiments where the container 200 is a syringe, the syringe (not shown) similarly has a body 210 and a shoulder 220. The body 210 defines a chamber for containing the product, such as the vaccine or cell composition. The shoulder 220 of the container 200 facilitates the connection of the apparatus 100 to the container 200, and makes it harder for the apparatus 100 to be inadvertently removed from the container 200, as discussed in more detail herein (with particular reference to FIGS. 3C, 4, and 5).

In some embodiments, the vial 200 further comprises a collar 230, a neck 240, and a head 250. A lid 260 may be connected to the head 250. As best seen in FIG. 2B, the shoulder 220 tapers to meet the collar 230. The collar 230 is wider than the neck 240 where collar 230 and neck 240 meet.

The apparatus 100 may comprise a first end 102 and a second end 104. The first end 102 and the second end 104 may be oppositely disposed, with a midsection 106 of the apparatus 100 disposed between the first end 102 and the second end 104. In use, the first end 102 may be positioned towards the shoulder 220 of the container 200, while the second end 104 may be positioned towards the base of the container 200. FIG. 1B shows an example of the approximate relative positioning of the first end 102, the second end 104, and the midsection 106.

### First Embodiment

With reference to FIG. 1A, in some embodiments the apparatus 100 comprises a body 110. The body 110 may be a tubular body. The cross section of the tubular body may comprise a circular, rounded, square, or rectangular shape, for example. The tubular body 110 defines a lumen 112. The lumen 112 may be configured to receive the vial 200. The tubular body 110 may comprise an outer surface 114. The outer surface 114 may comprise a plurality of surface variations, such as grooves, texturing, recesses, or protrusions. At least part of the outer surface 114 may define grooves or texture to facilitate grip. At least part of the outer surface 114 may be configured to receive a label. For example, the outer surface 114 may define a recess in which the label can be received. The surface variations of the outer surface 114 may be seen in more detail in FIGS. 1B and 1C.

FIG. 1B is a section view of the apparatus 100 shown in FIG. 1A, sectioned along the line 1B-1B as marked. The tubular body 110 has an inner diameter ID0 which may be substantially uniform along the length of the tubular body 110.

FIG. 1C is a close-up view of part of FIG. 1B as marked, showing the outer surface 114 in more detail. The outer surface 114 may comprise a primary outer surface 116 and a secondary outer surface 118. As best seen in FIG. 1C, a step 120 may offset the primary outer surface 116 and the secondary outer surface 118 to define a groove or a recess 122.

The recess 122 may be configured to receive a label (not shown) displaying information about the contents of the vial 200. The label may be printed directly on the outer surface 114, for example on the secondary outer surface 118. The label may be a separate item that is affixed to the outer surface 114, such as by adhesive. The label may be printed in the recess 122, such as by engraving or etching. The label may be configured to have a substantially smooth surface. The label may be configured to be scanned by a label scanner to allow easy identification of the label and the associated contents of the container 200. The label is configured to be retained on the outer surface 114 at subzero temperatures, and particularly at cryopreservation temperatures. The label may be transparent.

With reference to FIG. 1C, the recess 122 (in particular, the step 120) may comprise a label retainer 120A, 120B that is configured to retain the label in case the label detaches from the outer surface 114. For example, at least one of the steps 120 may be inclined at an acute angle to the secondary outer surface 118 so that a portion of the primary outer surface 116 may slightly overhang the secondary outer surface 118 to retain the label. FIG. 1C shows inclined step 120A, and regular/perpendicular step 120B. In some embodiments, step 120A is perpendicular to the secondary outer surface 118, while step 120B is inclined. In some embodiments, both of the steps 120A, 120B are inclined relative to the secondary outer surface 118. The label may be connected to the label retainer 120A, 120B, such as by adhesive.

In some embodiments, the primary outer surface 116 is textured to improve grip. The label may be received in the recess 122 and adhered to the secondary outer surface 118. The secondary outer surface 118 may be textured to increase the surface area available to receive the adhesive and may thereby reduce the likelihood of the label falling off.

The tubular body 110 may define an inner surface 124 disposed generally opposite to the outer surface 114. The inner surface 124 defines the boundaries of the lumen 112. The inner surface 124 may frictionally engage the outer/external surface of the container 200. The inner surface 124 is best shown in FIGS. 1B and 1C.

At least part of the inner surface 124 may define grooves or texture to facilitate grip. At least part of the inner surface 124 may be configured to receive the container 200. The inner surface 124 may comprise a primary inner surface 126 and a secondary inner surface 128. As best seen in FIG. 1C, a step 130 may offset the primary inner surface 126 and the secondary inner surface 128 to define a groove 132. The groove 132 may have an inner diameter ID3 that is larger than the inner diameter ID0 of the tubular body 110.

As shown in FIGS. 1A-1C, the apparatus 100 may comprise a connecting portion 140. The connecting portion 140 is configured to engage with the vial 200 and secure the apparatus 100 to the vial 200. The connecting portion 140 makes it more difficult for the apparatus 100 to be accidentally removed from the vial 200 when the vial 200 is received in the lumen 112.

The connecting portion 140 may be substantially ring shaped. The connecting portion 140 may be disposed at the first end 102 of the apparatus 100. The connecting portion 140 may extend from the tubular body 110. At least part of the connecting portion 140 may extend towards the lumen 112. In doing so, the connecting portion 140 may engage the vial 200 when the vial 200 is in the lumen 112.

In some embodiments, the connecting portion 140 comprises a first lip 142 (best shown in FIGS. 1B and 1C). The first lip 142 may define a first aperture to the lumen 112, with diameter ID1. The first lip 142 may be aligned with the shoulder 220 of the vial 200 when the vial 200 is received in the lumen 112 (such as shown in FIGS. 3A-3C). The first lip 142 may have a first elastic portion that is configured to enable the first lip 142 to stretch over the vial 200 (for example, over the vial shoulder 220) to secure the tubular body 110 to the vial 200 and make apparatus 100 harder to remove.

The first lip 142 may have a tapered portion 144. The tapered portion 144 narrows towards a thin edge 146. The tapered portion 144 may extend towards the lumen 112. When the first lip 142 is stretched over the vial 200, the tapered portion 144 and the thin edge 146 is configured to sit snugly against the external surface of the vial 200 so that the first lip 142 cannot be easily peeled off to remove the apparatus 100 from the vial 200. In particular, the thin edge 146 may sit substantially flush with the external surface of the vial 200.

The connecting portion 140 may further comprise a collar 148. The collar 148 may reinforce the lip 142 to strengthen the lip 142, in particular the thin edge 146. The collar 148 may be elastic.

Continuing to refer to FIGS. 1A-1C, the apparatus 100 further comprises a base 150 at the second end 104 of the apparatus 100. The base 150 may comprise a second lip 152 (best shown in FIGS. 1B and 1C). The second lip 152 may comprise an elastic portion. The second lip 152 may define a second aperture to the lumen 112, with diameter ID2.

The second lip 152 may have a tapered portion 154. When the second lip 152 is stretched over the vial 200, the tapered portion 154 is configured to sit snugly against the external surface of the vial 200 so that the second lip 152 cannot be accidentally peeled off to remove the apparatus 100 from the vial 200. The tapered portion 154 may extend towards the lumen 112.

### Example Materials and Dimensions

To provide a snug fit, the apparatus 100 may be sized to have a transition fit or interference fit. In some embodiments, the inner diameter ID0 of the tubular body 110 is smaller than the outer diameter of the vial body 210, marked as D_body in FIG. 2B. In some embodiments, the inner diameter ID3 of the groove 132 is smaller than the outer diameter of the vial shoulder 220, marked as D_shoulder in FIG. 2B. Selected example dimensions are provided in the Table below. Further dimensions are provided in FIG. 1D (apparatus 100), FIG. 2C (exploded view of vial 200), and FIG. 2D (vial 200).

| | Sleeve 100 | Vial 200 |
|---|---|---|
| At first lip 142 | ID1 = 22.9 mm | |
| At groove 132 | ID3 = 24.9 mm | D_shoulder = 25.0 mm |
| At body 110 | ID0 = 24.5 mm | D_body = 24.6 mm |
| At base 150 | ID2 = 20.9 mm | |

The apparatus 100 may be generally used with containers 200 having a cylindrical shape. The cylindrical containers 200 may be typically a vial or syringe. By way of example, an embodiment of the apparatus 100 for use with a vial or syringe may have a transparent portion to allow visibility of the container 200 received in the lumen 112. This may facilitate inspection of the contents of the container 200.

Some embodiments of the apparatus 100 may be adapted for use with other containers 200 that may be a different size to the example vial discussed herein.

The apparatus 100 may be configured to be used at subzero temperatures without mechanical or structural deterioration such as cracking. The apparatus 100 may have an operating range below approximately zero degrees Celsius, at which the apparatus 100 is configured to be mechanically and structurally stable. Embodiments of the apparatus 100 may be mechanically and structurally stable at cryopreservation temperatures, such as at or below approximately minus 80 degrees Celsius. The apparatus 100 may allow labelling of containers 200 that have been stored at cryopreservation temperatures between approximately minus 80 degrees Celsius to approximately minus 200 degrees Celsius. The apparatus 100 may allow labelling of containers 200 that have been stored at cryopreservation temperatures between approximately minus 135 degrees Celsius to approximately minus 196 degrees Celsius. Some containers 200 may be stored at minus 145 degrees Celsius. The apparatus 100 may be mechanically and structurally stable at cryopreservation temperatures between approximately minus 135 degrees Celsius to minus 196 degrees Celsius, and particularly at or around minus 145 degrees Celsius.

The apparatus 100 allows the quick labelling of containers 200. The apparatus 100 may avoid the containers 200 being taken out of cryofreeze conditions for extended periods of time. Cryofreeze or cryopreservation conditions may generally involve immersion of the container 200 in liquid nitrogen. The elastic properties of the apparatus 100 allow it to quickly and securely fit around the container 200 without slipping or peeling off, even at cold temperatures or when moisture/frost is present. The apparatus 100 may also improve friction/grip when the container 200 is being handled, reducing the likelihood of slippage and damage to the container 200.

The apparatus 100 may comprise a Ultra High Molecular Weight Polyethylene (UHMWPE) material such as TIVAR 1000 manufactured by Mitsubishi Chemical Group. TIVAR 1000 is FDA approved. TIVAR 1000 has a minimum service temperature of minus 200 degrees Celsius.

The material may be temperature resistant to heat and/or radiation to enable sterilisation. For example, the apparatus 100 may be made of material that allows heat sterilisation at around 55 degrees Celsius. TIVAR 1000 has a melting temperature of 135 degrees Celsius.

The apparatus 100 may comprise stainless steel in some embodiments.

The apparatus 100 may comprise a combination of materials. For example, UHMWPE may be used for the elastic connecting portion 140 and base 150 to enable a snug fit with the shoulder 220 of the container 200, and stainless steel may be used for the tubular body 110 to provide a rigid surface for ease of labelling and to provide some protection to the container 200 therein.

The wall thickness of the tubular body 110 may be thin in relation to the length of the tubular body 110 to allow the tubular body 110 to be easily stretched onto the container 200. For example, the tubular body 110 may have a wall thickness of approximately 0.7 mm and measure approximately 16 mm between the first and second ends 102, 104. The wall thickness may be around 0.5% to 1% of the length. The apparatus 100 may have some insulating properties, which may help to reduce heat transfer when the container 200 is removed from cryofreeze conditions.

### Container/Vial Arrangement

FIG. 3A is a perspective view of a container or vial arrangement 300, comprising the apparatus 100 applied to the vial 200. The apparatus 100 may have a label applied (not shown) to mark the contents of the vial 200. The label may be applied to the outer surface 114 of the body 110, for example. FIG. 3B is a section view along the line 3B-3B, and is a simplified view that does not show the groove 132 but is instead focused on the interaction between the connecting portion 140 and the external surface of the shoulder 220. Connecting portion 140, and thin edge 146 in particular, tapers to finish flush with the external surface of the shoulder 220. The base 150 of the apparatus 100 may sit flush with the base of the vial 200.

FIG. 3C is a close up view as marked on FIG. 3B, and shows the groove 132 engaging with the shoulder 220. The apparatus 100 engages with the shoulder 220 of the vial 200. The groove 132 is configured to secure the apparatus 100 to the container 200. In some embodiments, the groove 132 is shaped to receive the shoulder 220 of the container 200. FIG. 3C shows an embodiment of the vial 200 with the apparatus 100 applied. The tubular body 110 may comprise an elastic material so that the groove 132 may be deformable. The deformable groove 132 may facilitate a snug fit with the container 200 and particularly around the shoulder 220. For example, a lower corner 222 of the shoulder 220 may sit on the step 130, while the lip 142 of the connecting portion 140 hugs an upper corner 224 of the shoulder 220.

### Second Embodiment

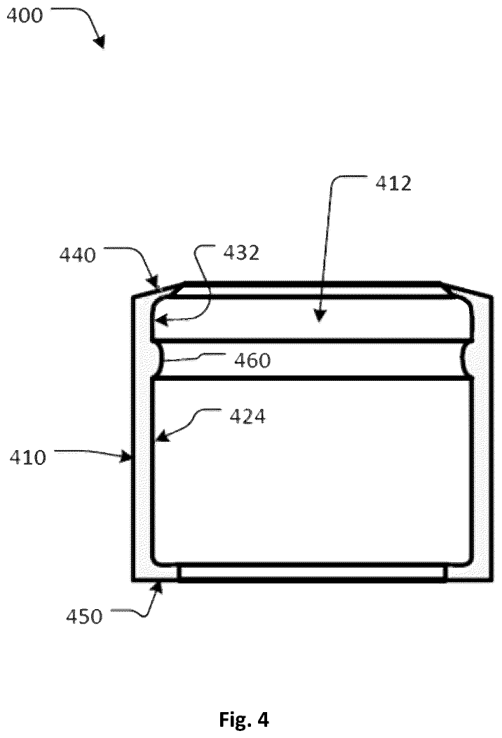

FIG. 4 is a section view of an apparatus or sleeve 400, showing an alternative configuration to the apparatus/sleeve 100.

The sleeve 400 comprises many of the same features as the apparatus 100. For example, the sleeve 400 comprises a tubular body 410 (analogous to tubular body 110), a connecting portion 440 (analogous to connecting portion 140), and a base 450 (analogous to base 150). An outer surface 414 of the tubular body 410 may be configured to receive a label. For example, a label (not shown) may be applied the sleeve 400, such as in a recess 422 (not shown) of the tubular body 410. The sleeve 400 may comprise a connector configured to secure the sleeve 400 to the container 200, for example by engaging with a corresponding connector on the container 200. For example, the body 410 may comprise a female connector configured to engage with a male connector on the container 200 to secure the body 410 to the container 200 received in the lumen 412. Alternatively, the body 410 may comprise a male connector configured to engage with a female connector on the container 200 to clamp the body 410 to the container 200 received in the lumen 412. The female connector may comprise a groove, hole, or slot. The male connector may comprise a ridge, pin, or tab.

The connector may be configured to secure the sleeve 400 to the container 200 at a cryopreservation temperature, such as at or below approximately minus 80 degrees Celsius. An inner surface 424 of the tubular body 410 (analogous to inner surface 124) defines a groove 432 (analogous to groove 132).

The sleeve 400 further comprises a ridge 460 defined on the inner surface 424. The ridge 460 is configured to engage with a corresponding groove on a container. The ridge 460 and the first lip 442 (analogous to first lip 142) are configured to secure the sleeve 400 to the container.

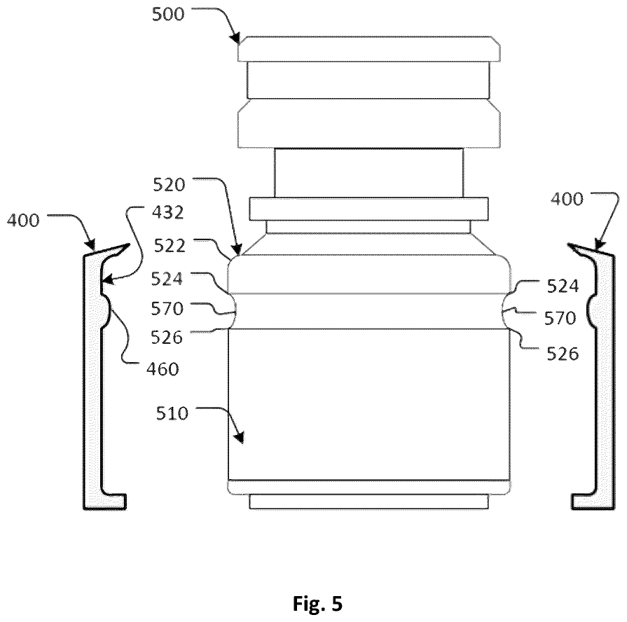

FIG. 5 shows an embodiment of a container 500 configured engage with the sleeve 400. A container arrangement comprising the container 500 and the sleeve 400 may be similar to the container arrangement 300. The container 500 comprises many of the same features as the container 200. For example, the container 500 comprises a body 510 (analogous to body 210), and a shoulder 520 (analogous to shoulder 220).

The container 500 further comprises a groove 570 to receive the ridge 460 of the sleeve 400. In FIG. 5, the sleeve 400 is shown spaced apart from the walls of the container 500 to better show the mating geometry of the groove 570 and the ridge 460. Similar to the relative sizing of the apparatus 100 and the vial 200, the sleeve 400 and container 500 are sized so that the sleeve 400 fits snugly around the container 500, such as with a transition or interference fit.

The ridge 460 is configured to be received in the groove 570 to allow the sleeve 400 to clamp on to the vial 500. Similar to the container/vial arrangement 300 and shoulder corners 222, 224, the corners 522, 524 of the shoulder 520 engage with the groove 432 above the ridge 460. The ridge 460 may improve the resistance to removal by engaging with an additional corner 526 of the vial 500. The corner 526 engages the underside of the ridge 460, pinching the ridge 460 together with corners 522, 524.

### Method of Use

The apparatus 100 and sleeve 400 are configured to receive a label containing information relating to the contents of the container 200 to which the apparatus 100 or sleeve 400 is to be applied. The label is configured to be applied to the apparatus 100/sleeve 400 before the apparatus 100/sleeve 400 is applied to the container 200. Some applications of the label may require heat transfer or generation, for example to activate an adhesive or to laser etch a label. Heat may damage the contents of the container 200 and at the very least, will undesirably involve the container 200 being removed from its subzero or cryofrozen storage conditions for a prolonged period. Accordingly, the label is preferably applied to the apparatus 100/sleeve 400 outside of the subzero or cryofrozen storage conditions; for example, at room temperature. The labelled apparatus 100/sleeve 400 is in turn is applied to the container 200, reducing the amount of time that the container 200 is removed from its subzero or cryofrozen storage conditions.

The apparatus 100/sleeve 400 may be applied to the container 200 by hand, wherein the operator wears appropriate personal protective equipment (PPE) or by using tools such as tongs or grippers to manipulate the container 200. In some circumstances, the operator may use an applicator to apply the apparatus 100/sleeve 400 to the container 200.

Application of the apparatus 100/sleeve 400 to the container 200 may generally involve two operations. Firstly, the apparatus 100/sleeve 400 is held in an “open” configuration where the apparatus 100/sleeve 400 is stretched so that the lumen is sized to receive the container 200. Secondly, the container 200 is placed in the lumen of the apparatus 100/sleeve 400, and the apparatus 100/sleeve 400 is released from the open configuration to the “locked” or “secured” configuration.

In some embodiments, at least part of the apparatus 100/sleeve 400 may be placed in contact with the container 200, such as with the shoulder 220. The rest of the apparatus 100/sleeve 400 may be gradually rolled over the rest of the container body 210.

### Applicator

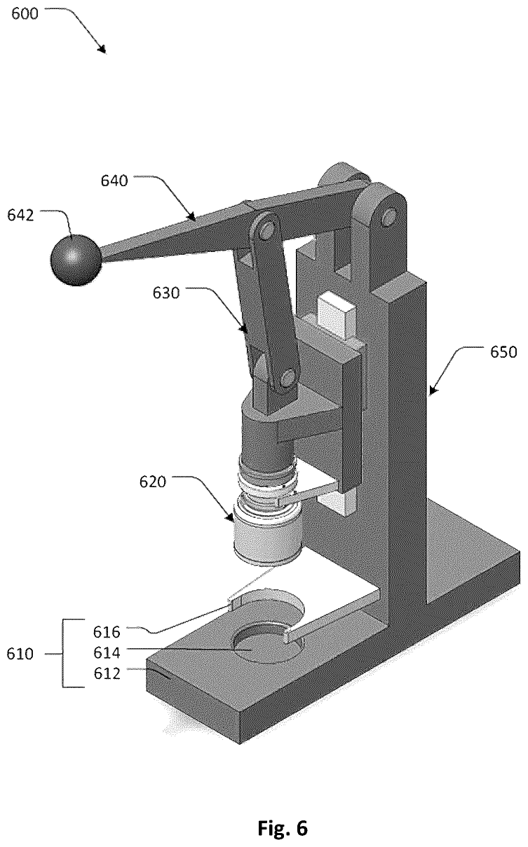

FIG. 6 shows an applicator 600 for the apparatus 100. The applicator 600 comprises a receiver 610 for receiving the container 200. The receiver 610 may comprise a base 612 which defines a recess 614 to receive a base of the container 200. The receiver 610 may further comprise a bracket 616 to support the body 210 of the container 200, such as midway along the container 200. The combination of the recess 614 and bracket 616 may securely hold the container 200.

The applicator 600 further comprises a holder 620 that is configured to hold the apparatus 100 or sleeve 400 in an open configuration to receive the container 200 in the lumen. For example, the holder 620 may hold the apparatus 100 or sleeve 400 in a stretched configuration so that when the container 200 is received in the lumen, releasing the apparatus 100 or sleeve 400 secures it to the container 200.

The receiver 610 and holder 620 may move relative to each other. For example, the receiver 610 may be configured to move towards the holder 620, and/or the holder 620 may be configured to move towards the receiver 610. The receiver 610 and/or holder 620 are adapted to move towards each other to place the apparatus 100 or sleeve 400 over the container 200.

The applicator 600 may further comprise a linkage 630 which is configured to move the receiver 610 and holder 620 relative to each other. The applicator 600 may further comprise an applicator arm 640 configured to actuate the linkage 630. The arm 640 may be pivotally and/or slidably connected to the linkage 630; for example, via a frame 650. The linkage 630 may be pivotally and/or slidably connected to the holder 620; for example, via the frame 650. Movement of the arm 640 may cause movement of the linkage 630 and therefore movement of the holder 620 relative to the receiver 610. The operator may move the arm 640 by applying an input force at a handle 642.

The arm 640 may be proportioned and arranged relative to the linkage 630 to provide a mechanical advantage that multiplies the input force applied by the operator at the handle 642. The multiplied input force may facilitate the application of the sleeve to the container 200, and in particular during repeated application of various labelled sleeves to respective containers.

In operation, the operator places the apparatus 100/sleeve 400 in the holder 620, which holds it in the open configuration. In some embodiments, at least part of the apparatus 100/sleeve 400 may be inverted or placed inside out in the holder 620. This is so that in embodiments where the apparatus 100/sleeve 400 is gradually rolled over the container 200, the apparatus 100/sleeve 400 is unrolled the right way up.

When the container 200 is securely placed in the receiver 610, the operator may apply an input force to the handle 642, which moves the arm 640. The holder 620 then moves towards the container 200 in the receiver 610.

After the apparatus 100/sleeve 400 is applied to the container 200, the operator lifts the handle 642 to move the holder 620 away from the container 200. The labelled container 200 may then be removed from the receiver 610.

Even in a temperature controlled environment, manual handling may cause some degradation of the vial's contents due to the warmth of the worker's hands being transmitted to the vial. While workers may wear PPE such as gloves, the gloves may affect the dexterity of the worker and may increase the likelihood of dropping the vial. The applicator 600 therefore minimises manual handling of the vial 200 when applying the label/apparatus 100.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An apparatus comprising:
a body defining a lumen for receiving a container, wherein the apparatus comprises a connecting portion configured to engage with the container and secure the apparatus to the container, and an outer surface of the apparatus is configured to receive a label;
wherein at least part of the connecting portion extends towards the lumen; and
wherein the apparatus has an operating range less than approximately minus 80 degrees Celsius, at which: (i) the apparatus is configured to be mechanically and structurally stable; and (ii) the label is configured to be retained on the outer surface.

2. The apparatus of claim 1, wherein the connecting portion comprises a first lip defining a first aperture to the lumen, the first lip having a first elastic portion.

3. The apparatus of claim 2, wherein the first lip comprises a tapered portion that extends towards the lumen.

4. The apparatus of claim 2 or claim 3, further comprising a groove defined in an inner surface of the body, wherein the first lip and the groove are configured to secure the apparatus to the container.

5. The apparatus of claim 2 or claim 3, further comprising a ridge defined on an inner surface of the body, wherein the first lip and the ridge are configured to secure the apparatus to the container.

6. The apparatus of any one of claims 2 to 5, wherein the connecting portion further comprises a collar.

7. The apparatus of any one of claims 1 to 6, wherein the body is configured to be stretched over the container to clamp on to the container when the container is received in the lumen.

8. The apparatus of any one of claims 1 to 7, wherein the operating range comprises temperatures between approximately minus 80 degrees Celsius to approximately minus 200 degrees Celsius.

9. The apparatus of any one of claims 1 to 8, wherein the operating range comprises temperatures between approximately minus 135 degrees Celsius to approximately minus 196 degrees Celsius.

10. The apparatus of any one of claims 1 to 9, wherein the apparatus comprises Ultra High Molecular Weight Polyethylene (UHMWPE) material.

11. The apparatus of any one of claims 1 to 9, wherein the apparatus comprises stainless steel.

12. The apparatus of any one of claims 1 to 11, further comprising a base, wherein the base comprises a second lip, wherein the second lip defines a second aperture to the lumen and the second lip comprises a second elastic portion.

13. The apparatus of any one of claims 1 to 12, wherein the body comprises a transparent portion to allow visibility of the container received in the lumen of the body.

14. The apparatus of any one of claims 1 to 13, further comprising a label retainer configured to retain the label when the label is received by the outer surface of the body.

15. The apparatus of claim 14, wherein the label is connected to the label retainer.

16. A container arrangement comprising:
the apparatus of any one of claims 1 to 15; and
a container comprising a shoulder, the apparatus configured to engage with the shoulder of the container.

17. The container arrangement of claim 16, further comprising a label applied to the apparatus.

18. A container arrangement comprising a container received in a sleeve, wherein the sleeve comprises a connector configured to secure the sleeve to the container.

19. The container arrangement of claim 18, wherein:
the shoulder of the container comprises a ridge;
the connector further comprises a groove; and
the ridge is configured to be received in the groove to clamp the sleeve on to the container.

20. The container arrangement of claim 18, wherein:
the shoulder of the container comprises a groove;
the connector further comprises a ridge; and
the ridge is configured to be received in the groove to clamp the sleeve on to the container.

21. The container arrangement of any one of claims 18 to 20, wherein the connector is configured to secure the sleeve to the container at a cryopreservation temperature.

22. The container arrangement of claim 21, wherein the cryopreservation temperature is at or below approximately minus 80 degrees Celsius.

23. The container arrangement of any one of claims 18 to 22, further comprising a label applied to the sleeve.

24. A sleeve comprising:
a body defining a lumen for receiving a container, and an outer surface of the body configured to receive a label; and
a first lip defining a first aperture to the lumen, the first lip having a first elastic portion configured to engage with the container;
wherein the body comprises a female connector configured to engage with a male connector on the container to secure the body to the container received in the lumen; and
wherein the first lip comprises a tapered portion that extends towards the lumen.

25. A sleeve comprising:
a body defining a lumen for receiving a container, and an outer surface of the body configured to receive a label; and
a first lip defining a first aperture to the lumen, the first lip having a first elastic portion configured to engage with the container;
wherein the body comprises a male connector configured to engage with a female connector on the container to clamp the body to the container received in the lumen; and
wherein the first lip comprises a tapered portion that extends towards the lumen.

26. The sleeve of claim 22 or claim 23, wherein the female connector comprises a groove, and the male connector comprises a ridge.

27. The sleeve of claim 22 or claim 23, wherein the female connector comprises a hole, and the male connector comprises a pin.

28. The sleeve of claim 22 or claim 23, wherein the female connector comprises a slot, and the male connector comprises a tab.

29. An applicator for the apparatus of any one of claims 1 to 15, for the container arrangement of any one of claims 16 to 23, or for the sleeve of any one of claims 24 to 28, the applicator comprising:
a container receiver configured to receive the container; and
a holder configured to hold the apparatus or sleeve in an open configuration;
wherein at least one of the container receiver and the holder are configured to move towards each other to place the apparatus or sleeve over the container.

30. A method for labelling a cryofrozen container containing a cell composition, wherein the method comprises:
printing a label onto a sleeve or an apparatus at room temperature;
applying the sleeve to the cryofrozen container.

31. The method of claim 30, wherein the sleeve is the sleeve of any one of claims 24 to 28.

32. The method of claim 30, wherein the apparatus is the apparatus of any one of claims 1 to 15.
